(19) United States
(12) Patent Application Publication
(10) Pub. No.: US 2009/0015953 A1
(43) Pub. Date: Jan. 15, 2009

(54) OPTICAL SURFACE FOR WIDE-ANGLE IMAGING

(76) Inventor: Graeme Jenkins, Victoria (AU)

Correspondence Address: CRAWFORD MAUNU PLLC, 1150 NORTHLAND DRIVE, SUITE 100, ST. PAUL, MN, 55120, US

(21) Appl. No.: 12/064,765

(22) PCT Filed: Aug. 21, 2006
(86) PCT No.: PCT/AU2006/001202

§ 371 Date: Jun. 30, 2008

(30) Foreign Application Priority Data
Aug. 25, 2005 (AU) 2005904632

(51) Int. Cl. G02B 5/10

(52) U.S. Cl. 359/868

(57) ABSTRACT

A method of designing an optical surface (110) for producing an image of an object (100) includes defining an object model (102) representing the object (100) that includes a plurality of object points. A magnification profile is defined which specifies a desired transverse magnification factor for at least each of said object points. For each object point of the object model, the method includes determining a curvature of the optical surface (110) at a point along at least one axis thereof, such that a magnification of an image (112) of the object model (102) at a corresponding image point corresponds with the desired magnification factor of the magnification profile. The optical surface (110) is then selected to have a substantially continuously varying curvature along the axis, and to include the determined surface point curvatures. Optical imaging apparatus including surfaces designed in accordance with the method are also provided. An exemplary embodiment of the invention provides a golf practice mirror which may be placed behind a golf ball relative to a golfer thereby enabling the golfer to view his or her swing, grip, stance and so forth, and substantially mitigating various undesirable forms of distortion characteristic of prior art practice mirrors.

### FIELD OF THE INVENTION

The present invention relates to optical imaging apparatus, and more particularly to optical apparatus, such as mirrors or lenses, which include surfaces designed to provide wide-angle imaging.

### BACKGROUND OF THE INVENTION

It is known to use optical apparatus, such as purpose-designed mirrors or lenses, to provide a wide-angle view in various circumstances in which such a view may be beneficial.

For example, wide-angle mirrors, typically having a convex surface, are used to provide an increased viewing angle in various applications. For example, slightly convex mirrors are sometimes provided as passenger side mirrors on motor vehicles, in order to increase the viewing angle available to the driver, and minimise the passenger-side blind zone.

Another application of such mirrors arises in relation to providing visual feedback during training of individuals, such as in sports training. In one particular example, a golfer may wish to assess and correct his or her own swing, grip, stance or so forth, by observation in a mirror. However, it may not be convenient, particularly when practising outdoors, to provide a large, plane mirror. Furthermore, the golfer needs to observe the ball also while swinging, and it is therefore desirable that the reflected image be within the field of view of the golfer while addressing the ball.

It is therefore known to use a small, convex, mirror located near a golf tee, such that the tee and mirror are both within the normal range of vision of the golfer when in position to hit a ball from the tee. A convex mirror may be of relatively small size, and provide a wide field of view, so that the golfer, addressing the ball, may see his or her full image in the mirror.

Various types of wide-angle lenses are also employed in various applications. For example, such lenses are commonly used in photography to increase the field of view that may be captured in a photographic image.

However, a common problem of all of the aforementioned types of wide-angle optical imaging apparatus is the distortion of the resulting image that typically occurs. It will be appreciated that some degree of distortion is almost inevitable when drawing a wide field of view into a small imaging area. For example, “fish eye” and other similar types of distortion are familiar results of the use of very wide-angle lenses. Similar forms of image distortion may occur with the use of convex mirrors. While such distortion may be deliberately employed, for example to produce interesting photographic effects, or as a form of entertainment, such as in carnival mirrors, generally such distortion is undesirable. For example, the distortion resulting from the use of convex rear-vision mirrors makes the location and distance of vehicles observed in the mirror difficult to judge. As a consequence, for safety reasons the use of such mirrors in motor vehicles is generally limited by legislation and, in many jurisdictions, convex mirrors may only be used for the passenger-side rear-vision mirror. Even in this case, legislation may require that the mirror be appropriately marked to warn the driver of the distortion introduced by the mirror, for example the mirror may be labelled to indicate that objects observed in the mirror may be closer than they appear.

Similarly, in a training application, such as the case of the golf mirror described previously, the use of a convex mirror results in a loss of correct perspective of the image observed in the mirror. This tends to cause those parts of the golfer's body, such as their legs, which are closer to the mirror to appear exaggerated in size as compared with more distant parts of the body. Since a significant portion of the image that is of interest to a golfer observing their own golf swing relates to the upper part of the body, this loss of correct perspective is a disadvantage that may significantly offset the benefits of using a mirror for self observation.

Accordingly, it is desirable to provide optical imaging apparatus, including surfaces designed to provide wide-angle viewing, that mitigates one or more of the aforementioned disadvantages of known wide-angle optical imaging apparatus. It is also desirable to provide a suitable systematic method for designing such optical surfaces.

It will be appreciated that any discussion of documents, devices, acts or knowledge in this specification is included to explain the context of the invention, and should not be taken as an admission that any of this material formed part of the prior art base or the common general knowledge in the relevant art on or before the priority date of any of the statements herein, or the claims appended hereto.

### SUMMARY OF THE INVENTION

In one aspect, the present invention provides a method of designing an optical surface for producing an image of an object, the method including the steps of:

defining an object model representing the object that includes a plurality of object points;

defining a magnification profile specifying a desired transverse magnification factor for at least each of said object points;

for each object point of the object model, determining a curvature of an optical surface at a point along at least one axis thereof, such that a magnification of an image of the object model at a corresponding image point corresponds with the desired magnification factor of the magnification profile; and

selecting the optical surface having substantially continuously varying curvature along said axis and which includes said determined surface point curvatures.

Accordingly, the invention mitigates the effects of distortion introduced by wide-angle optical imaging surfaces by enabling the type and degree of distortion introduced by a surface designed in accordance with the method to be controlled through the use of the object model and the magnification profile. By appropriate selection of the model, to include salient features of the object to be viewed in the optical surface, and the magnification profile, the optical surface may be custom-designed to ensure that any distortion introduced is of an acceptable nature in view of the intended application of the optical surface.

For example, in the case of a golf mirror the optical surface may be designed to ensure that when a golfer observes the image of their own golf swing in the mirror, the apparent perspective of the reflected image is of sufficiently natural appearance to enable the golfer to correctly judge the quality of their swing, in order to make any necessary corrections. As another example, the inventive method may be used to define an optical surface for use in a wide-angle rear-view mirror for a motor vehicle, such that the relative location of other vehicles, or other objects, within the critical region of the image (ie close in to the driver's vehicle, which would normally be a blind zone if a plane mirror is used) provides a substantially correct impression of the relative location and distance.

As will be appreciated, the inventive method may be used to design optical surfaces including mirror and lens surfaces.

The object model may include one or more lines and/or line segments. For example, a simple object model may consist of a single straight line, defined by its two end points. More complex object models may include a series of straight-line segments, defined by end points and/or vertices therebetween.

The object points included in the object model that are used in the design method may include the end points, vertices and/or a plurality of additional points located on straight or curved line segments making up an object model of any desired complexity.

In a preferred embodiment of the method, the object points of the object model are defined by their locations relative to a reference point located at or near the optical surface. The surface itself, that is designed according to the method, may similarly be defined in terms of the shape of the surface, or locations of points on the surface, relative to said reference point, or a different reference point. Where a reference point for defining the object model and/or the optical surface is not initially known, because the surface has yet to be defined, an iterative design process may be used whereby an initial surface design uses an approximate location for the reference point, which is subsequently refined one or more times based upon the resulting surface design.

In various embodiments of the invention, the magnification of the image of the object model at each object point may be substantially equal to the corresponding magnification factor of the magnification profile. Alternatively, various further modifications or refinements of the image surface may be made in accordance with embodiments of the invention, such that the correspondence between the magnification of the image of the object model at each object point and the magnification factor of the magnification profile is adjusted to provide a more acceptable result, or more practically realisable optical surface.

The magnification profile may take any arbitrary functional form, such that transverse magnification of each object point on the object model may be specified as desired. However, in one preferred embodiment the magnification profile is a constant, such that all object points may be reproduced in the image of the object model with the same transverse magnification factor.

It will be appreciated that a surface designed in accordance with embodiments of the invention produces a stigmatic image of the object model, since, by definition, each point on the object model maps, via the magnification profile, to a unique point in image space. However, the surface will not necessarily produce a stigmatic image of the actual object which, being idealised by the object model, may include points that are not sharply focused in image space. Furthermore, for large objects the paraxial approximation, upon which the conventional definition of magnification is based, may not apply, and accordingly the image of the object may nonetheless exhibit various forms of distortion.

Accordingly, the method may further include the step of adjusting the optical surface such that the image of the object more closely approximates an ideal object image. It will be understood that, in the present context, an ideal image of the object, or the object model, is an undistorted stigmatic image, and that such an image may be difficult or impossible to achieve in practice, although an acceptable approximation of the ideal may be found in accordance with preferred embodiments of the invention.

Adjusting the optical surface may include the steps of:

determining an image of the object model formed by the optical surface, the image including a plurality of image points;

for each image point, calculating an error distance which is the distance in image space between the image point and a corresponding point of an ideal optical image; and

modifying the optical surface to reduce a magnitude of the error distances.

In some embodiments of the invention, it may be possible to modify the optical surface so as to simultaneously reduce all error distances. Alternatively, the goal of modification may be to reduce a value of a single measure of overall error. For example, a suitable measure of overall error may be the mean square distance between image points and corresponding points on the ideal image, and the goal of modification may be to reduce the mean square distance.

In a preferred embodiment, the modification of the optical surface includes applying a stretch to the surface along an axis thereof, such that a projected distance between each image point and corresponding point on the ideal object image along said axis is reduced or eliminated.

The process of modification may be iterative, in order to arrive at a surface that produces an acceptable image, while remaining feasible to realise in practice.

In another aspect, the invention provides an optical imaging apparatus that includes an optical surface designed in accordance with the aforedescribed method. The optical imaging apparatus may consist of or include a mirror and/or a lens.

In a further aspect the invention provides a method of manufacturing an optical imaging apparatus for producing an image of an object, the method including selecting an optical surface designed in accordance with the aforedescribed method, and manufacturing an optical imaging apparatus including said defined optical surface.

Any one of a number of known methods may be employed to manufacture optical imaging apparatus, including mirrors and lenses. For example, lenses may be manufactured by machining or etching of suitable glass or plastics materials, while mirrors may be manufactured by machining or etching of suitable metals. Alternatively or additionally, a cast may be made from a machined or etched surface, and used in the subsequent manufacture, eg by molding, of a substrate upon which a reflective surface may be deposited, in the case that the imaging apparatus is a mirror. Similarly, a lens could be molded from a suitable clear plastic material. Other methods of manufacturing optical imaging apparatus may also be apparent to those skilled in the relevant manufacturing arts.

In yet another aspect, the invention provides an optical imaging apparatus for producing an image of an object represented by an object model including a plurality of object points, the apparatus including an optical surface which is characterised in that:

the surface has a substantially continuously varying curvature along at least one axis thereof,

said substantially continuously varying curvature being selected such that the optical surface produces an image of the object model wherein a transverse magnification of the image corresponds with a predetermined magnification profile which defines a magnification factor for each one of said object points.

In some embodiments, the transverse magnification of the image may be substantially equal to the magnification defined by the magnification profile. Alternatively, the correspondence between the magnification of the image and the magnification profile may be subject to adaptation or modification of the profile and/or the surface curvature so as to produce a more acceptable image of the object and/or a more practically realisable optical surface.

In one preferred embodiment, the continuously varying curvature of the optical surface is selected such that the optical surface produces an image of the object model wherein the transverse magnification of the image corresponds with a constant magnification factor applied to each one of said object points. It will be appreciated, however, that in alternative embodiments the magnification profile may take any arbitrary function or form.

The continuously varying curvature may be selected such that the surface is modified with respect to a reference surface for which the magnification is substantially equal to the predetermined magnification profile, such that an error distance, defined as a distance in image space between points of an image of the object model and corresponding points of an ideal object image, is reduced relative to a corresponding error distance of an image produced by said reference surface. For example, in preferred embodiments, the surface is stretched along an axis thereof such that a projected distance between each image point and a corresponding point on the ideal object image onto said axis is reduced or eliminated.

Further preferred features and advantages of the present invention will be apparent to those skilled in the art from the following description of preferred embodiments of the invention, which should not be considered to be limiting of the scope of the invention as defined in any of the preceding statements, or in the claims appended hereto.

### BRIEF DESCRIPTION OF THE DRAWINGS

Preferred embodiments of the invention are described with reference to the accompanying drawings in which:

FIG. 1 illustrates an object, in the form of a golfer, an object model, and an image of the object model produced by an optical surface, according to an embodiment of the invention;

FIG. 2 is a flowchart of a method of defining an optical surface according to a preferred embodiment of the invention;

FIG. 3 illustrates the definition of an optical surface in terms of curvature of surface elements according to a preferred embodiment of the invention;

FIG. 4 illustrates the definition of an optical surface by reference to an object model in accordance with a preferred embodiment of the invention;

FIG. 5 illustrates the surface profile of an optical surface according to an embodiment of the invention;

FIG. 6 shows a comparison of an actual object model image produced by the optical surface illustrated in FIG. 5, with an ideal object model image;

FIG. 7 illustrates a comparison of an actual object model image with an ideal object model image following modification of the surface profile of FIG. 5 in accordance with a preferred embodiment of the invention; and

FIG. 8 shows a comparison of the unmodified surface profile of FIG. 5 with surface profiles modified in accordance with preferred embodiments of the invention.

### DETAILED DESCRIPTION OF PREFERRED EMBODIMENTS

The present invention is directed to a method of designing an optical surface for producing an image of an object, and to optical apparatus including optical surfaces designed in accordance with the method. A preferred embodiment, and variations thereof, is described with reference to the particular example of a golf practice mirror, wherein the relevant optical surface is the reflective surface of the mirror. However, it will be appreciated by those skilled in the art that the method of the present invention may be used to design a variety of optical surfaces for use in different applications, including applications of both mirrors and lenses, and not limited to the specific example of a golf mirror disclosed herein. For example, embodiments of the design method, and optical surfaces designed thereby, could be used in other applications, such as providing wide-view rear-vision mirrors for use in motor vehicles. Other potential applications of the invention, and embodiments thereof, will be readily apparent to those skilled in the wide variety of technical fields in which mirrors and other optical devices are used.

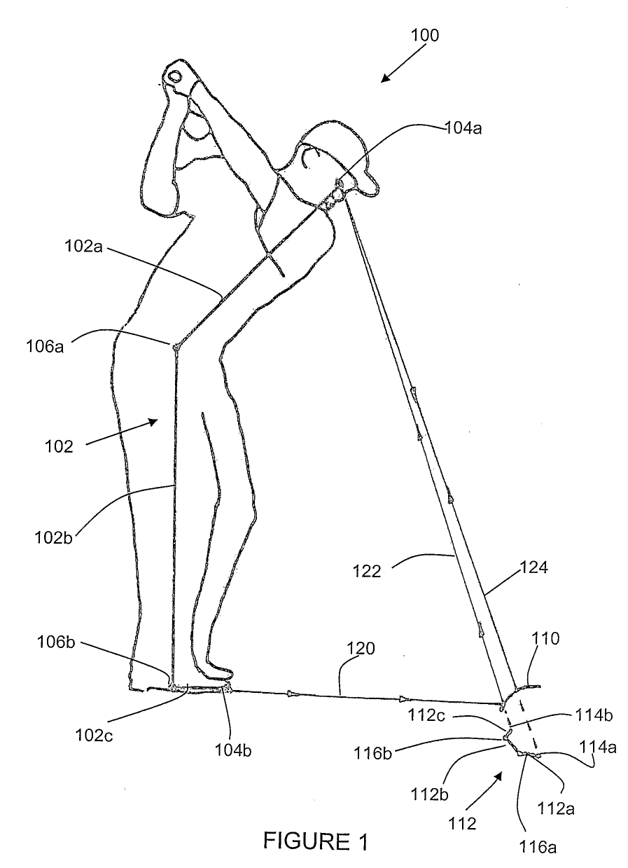

FIG. 1 illustrates an object, in the form of a golfer 100, an object model 102 and an object model image 112 produced by the optical surface 110, according to an embodiment of the present invention. According to a preferred embodiment of the inventive method, it is an object to design the topography of the surface of mirror 110 so as to produce an image 112 which is of acceptable quality for the purpose of enabling the golfer 100 to view his or her swing, grip, stance and so forth while addressing and striking a golf ball, by observation in the mirror 110.

In general, preferred embodiments of the method of the invention are based upon initially defining an object model 102 of the object 100 to be observed in the mirror 110. The object model 102 will generally be a representation of the object 100 that has been appropriately simplified, but which nonetheless retains the salient features of the object 100 which are to be acceptably reproduced in the image 112.

In the example of the golfer 100 illustrated in FIG. 1, the simplified object model 102 consists of three straight-line segments 102a, 102b, 102c. These three line segments of the object model 102 capture the salient features of the golfer's upper body, legs, and foot position respectively.

In this example, the object model is equally precisely defined by the two end points 104a, 104b, which represent the golfer's eye and toe respectively, as well as the two internal vertices 106a, 106b, representing the golfer's hips and heel. Such object models, having varying degrees of complexity, may be used to represent any object which may be the intended subject of viewing through an optical surface designed in accordance with the invention. For example, a very simple object model may consist of a single straight line defined by two end points, while a more sophisticated model, such as that shown in FIG. 1, includes a series of straight-line segments, defined by their end points and/or internal vertices. However, in view of the capabilities of modern computers, which may be used to implement the design method of the invention, object models of arbitrary complexity may be employed, including models consisting of or including a variety of straight and/or curved line segments or other elements.

Considering now the object model image 112 shown in FIG. 1, each of the salient features of the object model 102 is reproduced in the image 112. The object line segments 102a, 102b, 102c are reproduced as image line segments 112a, 112b, 112c. Similarly, the two end points 104a, 104b are reproduced as image end points 114a, 114b. Internal object model vertices 106a, 106b are reproduced in the image 112 as vertices 116a, 116b. Accordingly, the mirror 110 creates a mapping between the salient points of the object model in object space and corresponding image points of the object image in image space. In this context, the purpose of the method of the present invention, in the herein described embodiments, is to define the surface topography of mirror 110 so as to control the locations of the salient points of the object image 112 such that the resulting image of the golfer 100 is of acceptable quality for use in the intended application of golf training or practice. In particular, in this example the distortion of the image of the golfer 100 is desirably such that, from the viewpoint of the golfer's eye (co-located with object model point 104a) a sufficiently true perspective is retained in the image that the golfer 100 is able to make an accurate assessment of the quality of his or her own swing, grip, stance etc, and any adjustments or improvements that may be required thereto.

The mapping of the object model to the observed image is illustrated in FIG. 1 by rays 120, 122, 124. The ray 120 represents light transmitted to the mirror surface 110 from object model point 104b (representing the golfer's toe), while ray 122 represents the corresponding reflected light transmitted to the golfer's eye. Accordingly, the optical path represented by rays 120, 122 results in the golfer 100 observing image point 114b in the mirror 110. Similarly, the bidirectional ray 124 represents the path of light from object model point 104a (co-located with the golfer's eye) to the mirror 110, and its reflection back to the golfer's eye. This results in the observed image point 114a in the mirror 110.

With reference to the arrangement shown in FIG. 1, the problem to be addressed by embodiments of the invention is that of how to appropriately design the surface topography of mirror 110 so as to achieve an image 112 having the desired properties and qualities.

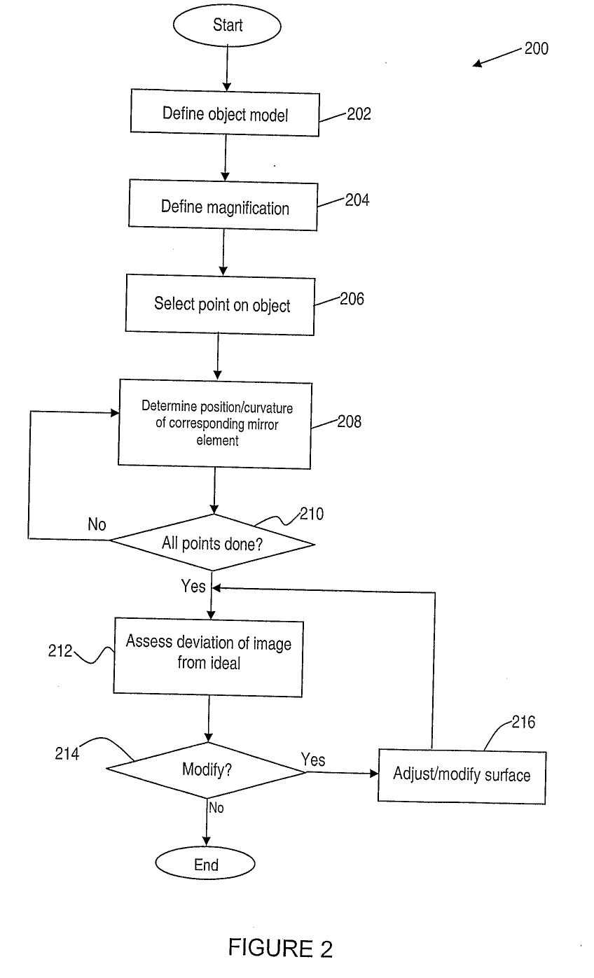

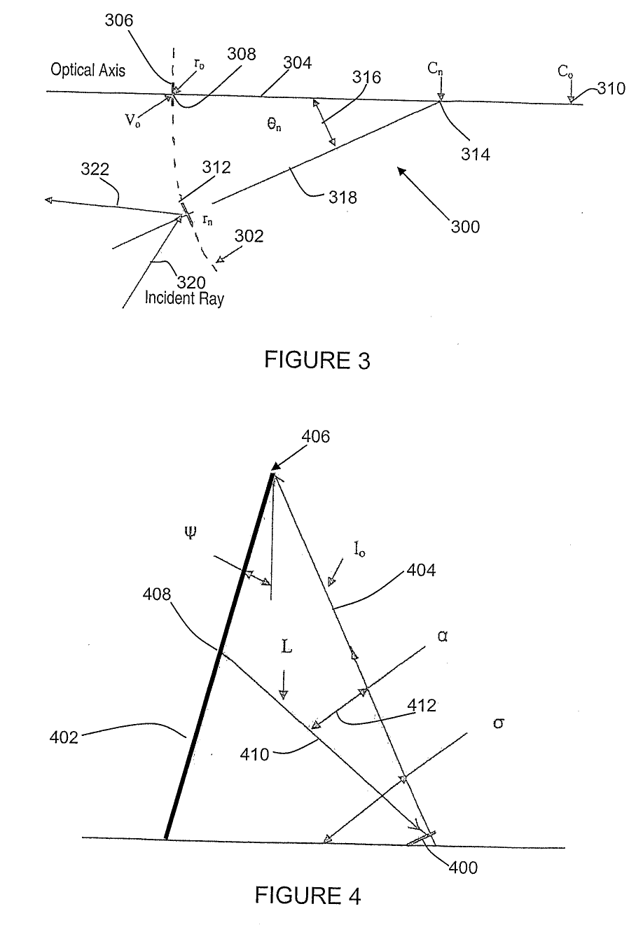

The flowchart 200, shown in FIG. 2, represents a preferred method of designing an optical surface according to the present invention. At step 202 of the method, an object model is defined as previously discussed with reference to FIG. 1. The subsequent steps, 204 to 216, are described in greater detail below with reference to FIGS. 3 to 8, but may briefly be summarised as follows. In step 204, a desired magnification profile is defined, which forms the basis for determining the surface topography of the optical surface to be designed. The design process then consists of iteratively executing steps 206 to 210, wherein for each one of a number of selected points on the object model, the curvature of a corresponding mirror element is determined in accordance with the defined magnification profile. Once all mirror elements have been determined, in accordance with the object model and the magnification profile, the decision 210 passes control to step 212, in which the actual object model image achieved by the optical surface is assessed, and compared with the ideal, undistorted, image. At step 214, a decision is made as to whether the deviation between the actual and ideal images is acceptable, and if not then, in step 216, an appropriate modification is made to the optical surface. Once no further modification is required, because an acceptable result has been achieved, the process terminates.

Turning now to a more detailed description of the process illustrated in flowchart 200, FIG. 3 shows how an optical surface may be defined in terms of the curvature of surface elements. The geometric optical diagram 300 shows the cross-sectional profile of an optical surface 302 through which passes a fixed optical axis 304. The remainder of the discussion in this specification focuses on this single cross-sectional profile of the optical surface, however it will be appreciated that a corresponding design technique may be applied through any section of the optical surface, and that in particular a two-dimensional design may be achieved corresponding to the one-dimensional method described herein by repeating the design process across one or more substantially orthogonal sections of the optical surface. However, in at least the presently described embodiment of the invention the one-dimensional procedure produces a suitable design for a complete optical surface, wherein a fixed spherical profile is used for the orthogonal dimension of the optical surface.

Again with reference to FIG. 3, a first element 306 of the optical surface is located on the predefined optical axis 304. The intersection of surface element 306 with the optical axis 304 defines a fixed reference point 308, also represented herein by the symbol V₀. For the purposes of the present design method, each element of the optical surface, including element 306, may be considered to be a small element of an equivalent spherical surface. As will be appreciated, a spherical surface may be defined in terms of its centre of curvature, and/or radius of curvature. Accordingly, optical element 306 may be defined by specifying its corresponding centre of curvature 310, denoted herein by the symbol C₀, which is located at a distance r₀ from the reference point 308 along optical axis 304.

The remainder of the optical surface 302 may be defined in terms of a series of further elements, eg element 312, each again considered as an arbitrarily small segment of an equivalent spherical surface having a centre of curvature located somewhere along optical axis 304. It will be appreciated that the surface may be defined in terms of an arbitrarily large number of such elements, each of which is, in an ultimate limit, of infinitesimal size. In the exemplary case, wherein the optical surface 302 is a reflective surface, a ray, eg 320, incident on element 312, will result in a corresponding reflected ray 322.

Accordingly, for example, surface element 312 is fully specified by its corresponding centre of curvature 314, denoted by the symbol Cₙ, along optical axis 304, or equivalently by its radius of curvature rₙ, along with the angle θₙ 316 formed between the optical axis 304 and the normal axis 318 joining element 312 to its corresponding centre of curvature 314.

In addition to the curvature of each element, eg 306, 312, the optical surface 302 is defined by the further constraint that it must be a continuous surface. Accordingly, once the reference point 308 has been defined, along with optical axis 304, and the curvature of each element making up the optical surface 302, the surface is fully specified. As will be appreciated, the one-dimensional process illustrated in FIG. 3 may be extended fully into two dimensions to define a complete two-dimensional optical surface, for example using computational methods such as finite element analysis, however in accordance with the embodiment described herein a fixed curvature is applied across the orthogonal dimension of optical surface 302, which may be, for example, equal to the curvature of the surface element 306 lying on optical axis 304.

Turning now to FIG. 4, there is shown a diagram illustrating the process of constructing the optical surface of a mirror 400 for use in the exemplary application of providing a practice mirror for golf training. For the sake of simplicity, a simplified object model 402 is illustrated in FIG. 4, which represents the golfer as a single straight line having, for example, end points located at the golfer's heels and at the golfer's eye.

According to the exemplary construction illustrated in FIG. 4, the optical axis 404 is a line connecting an element of the surface of mirror 400 with the golfer's eye, ie the viewing point 406. The distance between the surface of mirror 400 and point 406 along the optical axis 404 is represented by the symbol l₀.

As indicated by step 204 in flowchart 200, the next step in the process of designing the optical surface of mirror 400 is to define a desired magnification profile for the object model 402. A magnification profile, in this context, is a function that maps each point on the object model 402 that will be used in the construction of the mirror surface to a corresponding magnification factor. The magnification factor determines the transverse magnification of an element of the image observed in the mirror 400 that corresponds with an element of the object located at each object point of the object model 402. In the example described herein, a simple constant magnification profile is used. That is, the objective is to design a surface which provides equal transverse magnification to all elements of the object model 402. It will be appreciated, however, that through the use of appropriate computational methods, the design procedure may be applied to design a surface of mirror 400 that provides any arbitrary magnification profile.

In the present discussion, the magnification of the object corresponding with point 406, ie along the optical axis, is denoted by the symbol m₀. This magnification is related to the distance between the point 406 and the mirror surface, denoted by l₀, and the radius of curvature at the corresponding mirror element, r₀, by the following formula:

$${M}_{0} = - \frac{{r}_{0}}{2 {l}_{0} - {r}_{0}} \qquad ( 1 )$$

Accordingly, for a desired magnification m₀ and distance l₀ between viewing point 406 and mirror 400, the required radius of curvature of the corresponding mirror element is given by:

$${r}_{0} = \frac{2 {m}_{0} {l}_{0}}{{m}_{0} - 1} \qquad ( 2 )$$

For example, for a magnification of 5%, at a distance l₀=−1.5 m from point 406, (using the sign convention that distances on the object side of the mirror are negative, and on the image side of the mirror are positive) the required radius of curvature r₀ equals 15.8 cm.

The process of determining the required radius of curvature r is then repeated for a series of object points located on the object model 402. An exemplary object point 408 is shown in FIG. 4, and this object point is located a distance L from the surface of mirror 400. The angle 412 between optical axis 404 and the line 410 joining point 408 to mirror 400 is denoted by the symbol α. For the case of constant magnification profile, it is possible to express the required angle α and radius of curvature r which define the corresponding element on the surface of mirror 400 in terms of the previously defined radius r₀, length l₀ and the angle θ between the optical element and the optical axis as follows:

$$\begin{matrix}r = L \frac{{r}_{0}}{{l}_{0}} & ( 3 ) \\ α = artan ( \frac{r sin θ}{\vert {l}_{0} \vert} ) + 2 θ & ( 4 )\end{matrix}$$

By repeating this process for a sufficiently large number of object points eg 408, located on the object model 402, the profile of the optical surface of mirror 400 may be fully determined.

A potential difficulty arising from the abovementioned procedure is that, initially, the location of all points on the optical surface of mirror 400 is not known, since it is the purpose of the procedure to determine this surface. Accordingly, the distance L between each object point 408 and the optical surface also is not known, although it is required in order to determine the surface. In practice, however, this is not a significant problem. In a typical case, the distance between the object model 402 and the mirror 400 is much greater than any variation in the topography of the optical surface. Accordingly, the distance may readily be approximated, for example by the distance to any previously determined point on the surface of mirror 400, such as the initial element located on optical axis 404. If the resulting surface profile is not sufficiently accurate as a result of this approximation, an iterative process may be used wherein each successive approximation to the surface uses the previous approximation to determine the required distances. Such an iterative process may be repeated as required until convergence is achieved, whereby each successive approximation is only insignificantly different from the previous approximation.

It will also be appreciated that while relatively simple equations (3) and (4) may be derived for the case of a constant magnification profile, if a more complex profile is desired it may be necessary to employ computational or numerical methods to determine an optical surface which is not amenable to expression via closed-form equations. With the availability of modern computing hardware and computational methods, it will be readily understood that this poses no obstacle to the practical design of optical surfaces corresponding with any desired object model and magnification profile.

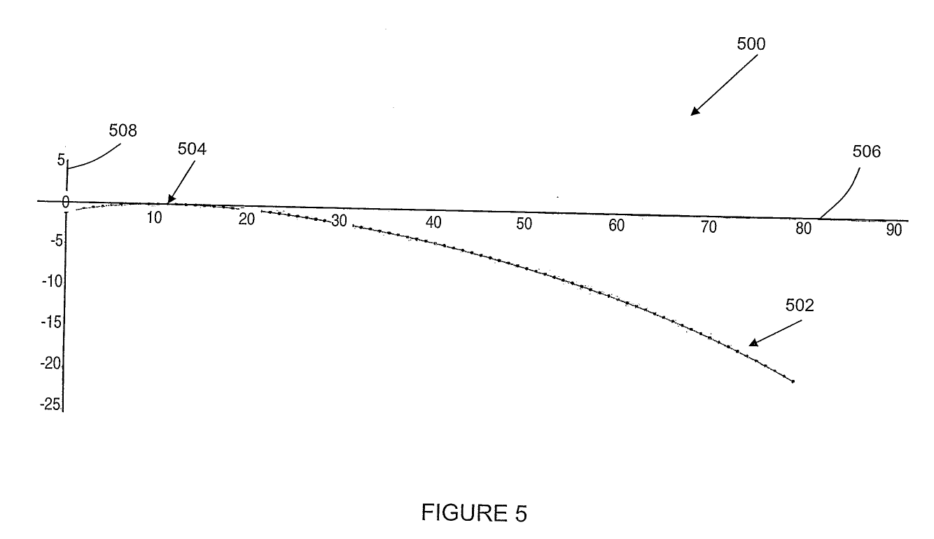

FIG. 5 shows a graph 500 depicting the computed mirror surface profile 502 resulting from the design process illustrated in FIG. 4. The point 504 on the surface 502 is the reference point V₀, having radius of curvature r₀ located on the optical axis 404 connecting the vertex 504 of the mirror surface with the viewing point 406. As will therefore be appreciated, the x-axis 506 of the graph 500 represents distance across the cross-section of the mirror surface, while the y-axis 508 represents the dimension parallel to the optical axis. The numerical values in the example are in millimetre units. The graph 500 illustrates how a complete optical surface 502 may be defined by the aforedescribed procedure using a finite number of object points, eg 408, represented by the points in the graph 500.

While the surface 502 may be fully defined by the method described above with reference to FIG. 4, resulting in a mirror 400 in which an image of the object model 402 will be produced having the desired magnification profile, other forms of distortion may nonetheless be present in the image. Accordingly, preferred embodiments of the method include further steps 212 to 216, the purpose of which is to modify the surface profile in order to produce an improved image.

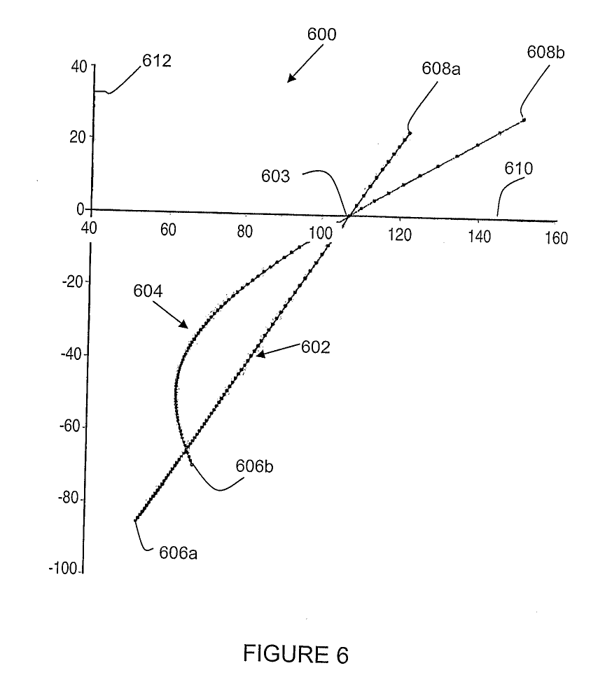

FIG. 6 shows a graph 600 illustrating the difference between an actual image 604 of object model 402 produced by a mirror having surface profile 502, as compared with an ideal image 602. In this graph 600, the x-axis 610 represents the optical axis of the corresponding design geometry, while the y-axis 612 represents a perpendicular dimension of the system. All numerical values in the example are once again in millimetre units.

Since the object model 402, in this example, is a straight line, the ideal image of the object model is also a straight line in image space, shown as line 602 in graph 600. That is, an ideal image of object model 402 existing in object space is the perfectly scaled-down replica 602 appearing in image space. By comparison, the actual image resulting from observing the object model 402 in the mirror having surface profile 502 from viewing position 406 is the curved line 604, which has been computed from the geometry illustrated in FIG. 4, and the resulting surface profile 502. While the single constraint of transverse magnification profile has been achieved, distortions in depth and scale of the image 604 are apparent, and the only point in the actual image which coincides with the corresponding point in the ideal image is point 603, which is located directly on the optical axis. The difference between the actual image 604 and the ideal image 602 may be represented by a series of error distances, which are defined as the distance in image space between each actual image point and a corresponding point on the ideal object image 602. Thus, for example, an error distance between the end point 606a of ideal image 602 and the end point 606b of actual image 604 is defined as the distance between these two points. Similarly, a corresponding error distance exists between the two opposing end points 608a and 608b.

A modification to the surface profile 502 may therefore be applied in order to reduce the error distances. Such modification may take many forms, some of which may result in a reduction of all error distances, while others may result in an overall reduction in the error, although some error distances may be decreased only at the expense of an increase in others. Accordingly, depending upon the modification to be applied, a suitable measure of improvement should be defined, which in some cases may be a reduction in all error distances, and in others may be a reduction in an overall measure of the error, such as the mean squared distance between corresponding points on the actual image 604 and ideal image 602.

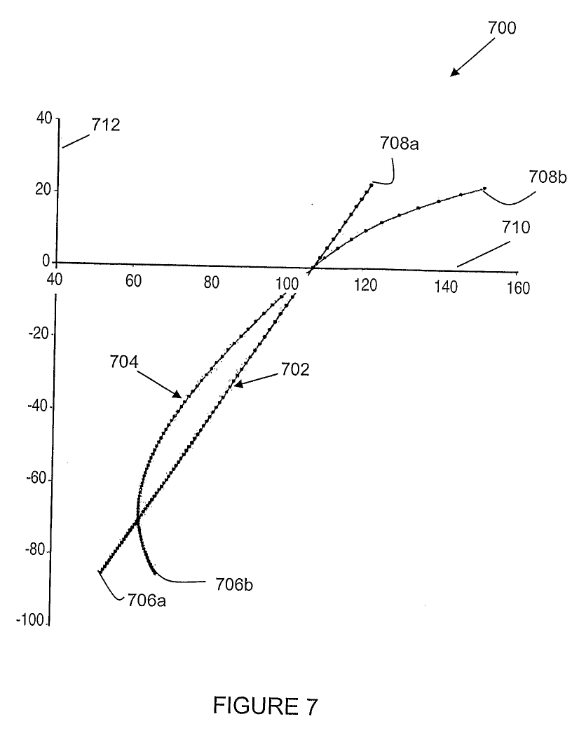

FIG. 7 shows a graph 700 illustrating the effect of one possible modification of surface profile 502. As in the graph 600, the x-axis 710 represents the optical axis and the y-axis 712 a perpendicular dimension, and all exemplary values are in millimetre units. The modification exemplified by FIG. 7 is a stretch of the optical surface along an axis corresponding with the surface profile 502. The amount of stretch along the profile is selected to cause corresponding points on the ideal image 702 and the actual image 704 to align along the Y axis of the graph 700. That is, corresponding end points 706a and 706b of ideal image 702 and actual image 704 have the same Y coordinate following the modification of the surface. Similarly, opposed end points 708a and 708b also have the same Y coordinate following the stretch. Eliminating the error between the points on the ideal image 702 and actual image 704 in the Y dimension results in an overall decrease in all error distances. The end result is therefore an actual image 704 that more closely approximates the ideal image 702.

It is similarly possible to adjust the location of each surface element of the optical surface 502 in order to eliminate errors in the X coordinate of each corresponding point in the actual and ideal images. However, the result of such a modification, which aims to completely eliminate the error, may result in an optical surface which is difficult to realise in practice, or which is otherwise unacceptable in the intended application.

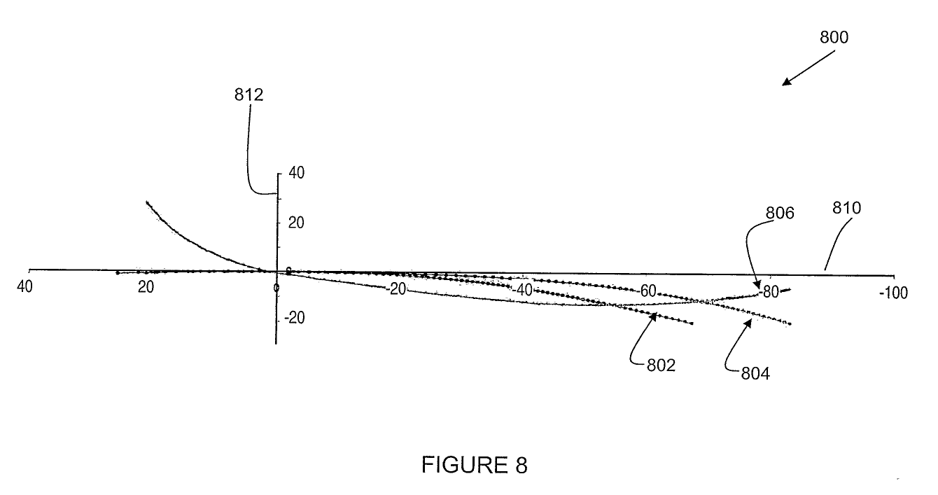

The effect of such modifications are illustrated in the graph 800 shown in FIG. 8. The graph 800 follows the same axis orientation and dimensional conventions as the graph 500, ie the x-axis 810 represents distance across the cross-section of each optical surface, the y-axis 812 runs parallel to the optical axis, and all exemplary values are in millimetre units. Three surface profiles are shown in FIG. 8. Profile 802 is the original profile, corresponding with profile 502 illustrated in FIG. 5. Profile 804 is the stretched modified surface profile corresponding with the improved actual image 704 illustrated in FIG. 7. Profile 804 is, generally, a “stretched” version of the initial profile 802, and may feasibly be realised in practice in order to provide a golfing practice mirror which provides a training golfer 100 with an image having acceptably accurate perspective. The final surface profile 806 illustrated in graph 800 has a concave form and would be both difficult to manufacture, and impractical for use in the intended application of golf practice or training. Accordingly, although surface profile 806 in principle provides an error free image of the object model 402, it does not represent a preferred surface profile for a golf mirror.

It will therefore be appreciated that the process of modifying the optical surface 502 in order to refine the image quality is an iterative process that may involve evaluation at each stage to arrive at an acceptable compromise between image distortion, surface shape and the end application. Furthermore, as will be understood from the foregoing discussion, the exemplary process of modification generally utilises the initial surface profile 502, for which the magnification is substantially equal to the predetermined transverse magnification profile, as a reference surface. A modified surface is then generated, for example by applying a stretch to the reference surface, for which a relevant measure of the error distance is reduced relative to the reference surface, while preferably also satisfying other practical constraints.

Once a suitable surface has been designed, optical imaging apparatus, such as the golf mirror described herein, or other types of mirror or lens apparatus, may be manufactured in accordance with the design.

Any one of a number of known methods may be employed to manufacture optical imaging apparatus, including mirrors and lenses. For example, lenses may be manufactured by machining or etching of suitable glass or plastics materials, while mirrors may be manufactured by machining or etching of suitable metals. Alternatively or additionally, a cast may be made from a machined or etched surface, and used in the subsequent manufacture, eg by molding, of a substrate upon which a reflective surface may be deposited, in the case that the imaging apparatus is a mirror. Similarly, a lens could be molded from a suitable clear plastic material. Other methods of manufacturing optical imaging apparatus may also be apparent to those skilled in the art.

From the foregoing description, it will be readily apparent to those skilled in the art that many variations of the method for designing an optical surface, as well as the optical surfaces designed thereby, and optical apparatus including such optical surfaces, are possible in accordance with the invention. The invention is thus not to be limited to the particular embodiments described, but rather is defined by the claims appended hereto.

1. A method of designing an optical surface for producing an image of an object, the method including the steps of:
defining an object model representing the object that includes a plurality of object points;
defining a magnification profile specifying a desired transverse magnification factor for at least each of said object points;
for each object point of the object model, determining a curvature of an optical surface at a point along at least one axis thereof, such that a magnification of an image of the object model at a corresponding image point corresponds with the desired magnification factor of the magnification profile; and
selecting the optical surface having substantially continuously varying curvature along said axis and which includes said determined surface point curvatures.

2. The method of claim 1 wherein the object model includes one or more line segments.

3. The method of claim 1 wherein the object model includes a plurality of straight-line segments defined by end points thereof and/or vertices therebetween.

4. The method of claim 2 wherein the object points of the object model include the end points of line segments of the object model and/or vertices between line segments of the object model.

5. The method of claim 4 wherein the object points further include one or more additional points located on line segments of the object model.

6. The method of claim 1 wherein the magnification profile is a constant transverse magnification factor.

7. The method of claim 1 wherein the magnification of the image of the object model at each object point is substantially equal to a corresponding magnification factor of the magnification profile.

8. The method of claim 1 including the further step of adjusting the optical surface such that the image of the object more closely approximates an ideal object image.

9. The method of claim 8, wherein the step of adjusting the optical surface includes:
determining an image of the object model formed by the optical surface, the image including a plurality of image points;
for each image point, calculating an error distance which is the distance in image space between the image point and a corresponding point of an ideal optical image; and
modifying the optical surface to reduce a magnitude of the error distances.

10. The method of claim 9 wherein said magnitude of error distances is a mean square distance between the image points and corresponding points on the ideal image and the step of modifying the optical surface has the objective of reducing the mean square distance.

11. The method of claim 9 wherein the step of modifying the optical surface includes applying a stretch to the surface along an axis thereof, such that a projected distance between each image point and a corresponding point on the ideal object image along said axis is reduced.

12. A method of manufacturing an optical imaging apparatus for producing an image of an object, the method including the steps of:
selecting an optical surface for producing said image by
defining an object model representing the object that includes a plurality of object points,
defining a magnification profile specifying a desired transverse magnification factor for at least each of said object points,
for each object point of the object model, determining a curvature of an optical surface at a point along at least one axis thereof, such that a magnification of an image of the object model at a corresponding image point corresponds with the desired magnification factor of the magnification profile, and
selecting the optical surface having substantially continuously varying curvature along said axis and which includes said determined surface point curvatures; and
manufacturing an optical imaging apparatus including said selected optical surface.

13. An optical imaging apparatus including an optical surface designed by
defining an object model representing the object that includes a plurality of object points;
defining a magnification profile specifying a desired transverse magnification factor for at least each of said object points;
for each object point of the object model, determining a curvature of an optical surface at a point along at least one axis thereof, such that a magnification of an image of the object model at a corresponding image point corresponds with the desired magnification factor of the magnification profile; and
selecting the optical surface having substantially continuously varying curvature along said axis and which includes said determined surface point curvatures.

14. An optical imaging apparatus for producing an image of an object represented by an object model including a plurality of object points, the apparatus including an optical surface which is characterized in that:
the surface has a substantially continuously varying curvature along at least one axis thereof,
said substantially continuously varying curvature being selected such that the optical surface produces an image of the object model wherein a transverse magnification of the image corresponds with a predetermined magnification profile which defines a magnification factor for each one of said object points.

15. The optical imaging apparatus of claim 14 wherein the continuously varying curvature of the optical surface is selected such that the optical surface produces an image of the object model wherein the transverse magnification of the image corresponds with a constant magnification factor applied to each one of said object points.

16. The optical imaging apparatus of claim 14 wherein the transverse magnification of the image is substantially equal to the magnification defined by the magnification factor for each one of said object points.

17. The optical imaging apparatus of claim 14 wherein the continuously varying curvature of the optical surface is selected such that the surface is modified with respect to a reference surface for which the magnification is substantially equal to the predetermined magnification profile, such that an error distance, defined as a distance in image space between points of an image of the object model and corresponding points of an ideal object image, is reduced relative to a corresponding error distance of an image produced by said reference surface.

18. The optical imaging apparatus of claim 17 wherein the error distance is a mean-square distance between the points of the image of the object model and the corresponding points of the ideal object image.

19. The optical imaging apparatus of claim 17 wherein the modification to the optical surface includes a stretch along an axis thereof such that a projected distance in image space between the points of the image of the object model and the corresponding points of the ideal object image onto said axis is reduced.

20. The optical imaging apparatus of claim 13, wherein the optical surface is a mirror.

21. A practice mirror for producing a reflected image of a golfer, wherein the golfer is represented by a golfer object model including a plurality of golfer object points, and wherein the practice mirror includes a reflective surface which is characterized in that:
the reflective surface has a substantially continuously varying curvature along at least one axis thereof,
said substantially continuously varying curvature being selected such that the reflective surface produces a reflective image of the golfer object model wherein the transverse magnification of the image corresponds with a predetermined magnification profile which defines a magnification factor for each one of said golfer object points.

22. The practice mirror of claim 21 wherein the golfer object model includes a plurality of straight-line segments representing a stance of a golfer addressing a golf ball.

23. The practice mirror of claim 21 wherein the golfer object model includes three straight-line segments capturing salient features of upper body, leg and foot positions respectively of a stance of a golfer addressing a golf ball.

24. The practice mirror of claim 21 wherein the continuously varying curvature of the reflective surface is selected such that the reflective surface produces a reflected image of the golfer object model wherein the transverse magnification of the image corresponds with a constant magnification factor applied to each one of said golfer object points.

25. The practice mirror of claim 21 wherein the continuously varying curvature of the reflective surface is selected such that the surface is modified with respect to a reference surface for which the magnification is substantially equal to the predetermined magnification profile, such that an error distance, defined as a distance in image space between points of an image of the golfer object model and corresponding points of an ideal golfer object image, is reduced relative to a corresponding error distance of an image produced by said reference surface.
